(19) United States
(12) Patent Application Publication
(10) Pub. No.: US 2019/0042603 A1
(43) Pub. Date: Feb. 7, 2019

(54) Automated Generation of Data Schemata for Application Programming Interfaces

(71) Applicants: Sungho Park, Chicago, IL (US); Suyong Won, Seoul (KR)

(72) Inventors: Sungho Park, Chicago, IL (US); Suyong Won, Seoul (KR)

(21) Appl. No.: 15/665,675

(22) Filed: Aug. 1, 2017

(51) Int. Cl. G06F 17/30; G06F 9/54

(52) U.S. Cl. CPC G06F 17/30292; G06F 9/541

(57) ABSTRACT

Methods for automatically generating schemata of input and output data of application programming interfaces are described. Providers of an API make requests to an API. A computer program collects the data of the requests and responses from the API. Another computer program extracts schemata of the data. JSON schema, XSD and YAML schema are used in extracting schemata of JSON-, XML- and YAML-formatted data respectively. If extracted schemata from a series of data is different element by element, a schema is created in such a way that its validation results for all elements are true.

### BACKGROUND OF THE INVENTION

Application Programming Interfaces (API) are often used to exchange and process data among different applications in IT systems. A routine can be set up to create APIs for applications following specified requirements. Even though the APIs are all created from a routine, their requirements for input and output data will be different because different applications take and return input and output data of different schemata.

In communicating specifications of an API, providers can manually write schemata of input and output data. However, this method requires customization for every newly created APIs. This disclosure relates to expressing schemata of input and output data of an API without manual writing.

### BRIEF SUMMARY OF THE INVENTION

Knowing schemata of input and output data is important in several regards. Schemata can be provided as a part of API specification documents to external parties. A schema for input data can validate a request before the request goes to the application behind an API. When a user wants to search requests whose input or output data contain a particular value for an attribute, schemata can provide a list of possible attributes the user can search.

In order to secure schemata of input and output data, a routine can request providers of APIs to specify names and types of attributes. However, this approach requires the providers to manually enter specifications of input and output data. Consequently, the approach can take a substantial amount of work and time if the number of APIs to be created is large. The object of this invention is to automatically generate schemata of input and output data that goes to and comes out of an API.

Methods and computer program instructions are described for providing an automated way of discovering schemata of input and output data for an API. First, providers of an API send a series of representative input data to a computer program. The computer program makes requests with the given series of data, receive responses, and make a series of output data from the responses. Then it sends the two series of data to another program to extract schemata. The second program uses publicly well-known schema design, such as JSON (JavaScript Object Notation) schema, to extract and express schemata of the series of input and output data.

### BRIEF DESCRIPTION OF THE DRAWINGS

FIG. 1 depicts the overall process of a certain embodiment of the invention.

FIG. 2 depicts the overall process of acquiring series of input and output data from requests and responses in a certain embodiment of the invention.

FIG. 3 depicts the overall process of extracting schemata from a series of data in a certain embodiment of the invention.

### DETAILED DESCRIPTION OF THE INVENTION

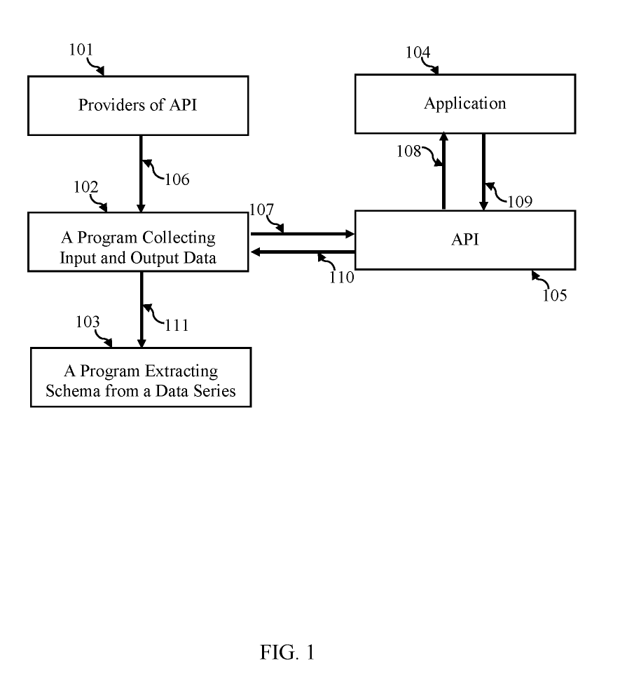

Preferred embodiments of the invention provide a method, system and computer programs that generate schemata of input and output data of an API. FIG. 1. shows how schemata are obtained at high-level in a certain embodiment. The process starts with a provider 101 providing a series of representative input data 106 to a computer program 102. A provider is an entity offering APIs to external parties. In practice, it is likely a creator of offered APIs. A provider understands its APIs and can provide example input data.

Upon receiving a series of input data, the computer program makes requests 107 to a target API 105. The API runs the application 104 with the series of input data, receives output data 109, and returns responses 110.

For each request, the computer program 102 waits for a response. Once all requests complete, the computer program retrieves output data from each response to make a series of output data. Then, it invokes another program 103 twice, one time with a series of input data acquired from the provider and the other time with a series of output data from the API. For each invoke, the program 103 extracts a schema from a given series of data.

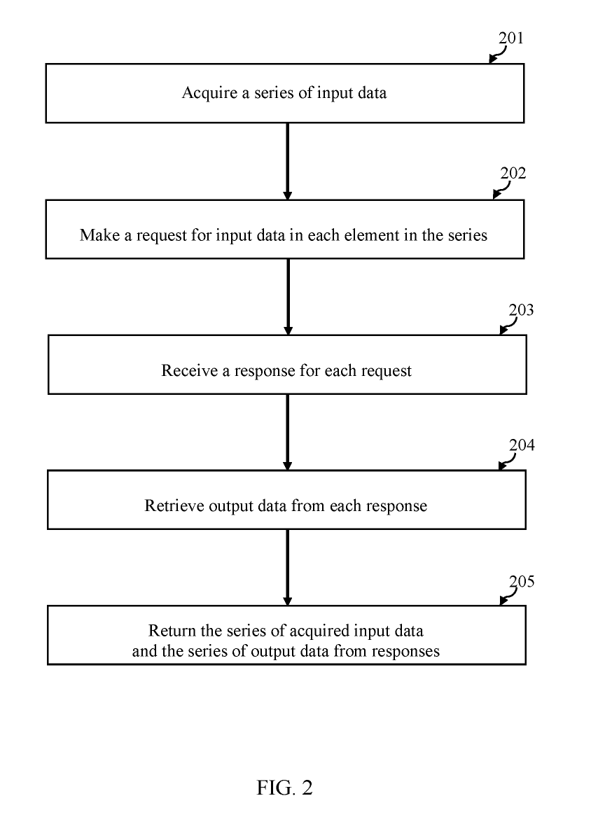

FIG. 2 shows how the program 102 interacts with an API 105 in a certain embodiment. In 201, it first receives a series of input data. In 202, for each data element in the series, it makes a request to a target API. A request 107 is a collection of input data and necessary information for an API to understand a client's needs. If all APIs the computer program makes requests to are created from a certain routine and require same set of auxiliary information, the program can store auxiliary information beforehand and create a request with given input data automatically. If the computer program interacts with APIs requiring different, for example, protocols, data format and etc., the computer program can ask providers these sets of information in making requests.

In 203, the program waits a response for each request. If an API is asynchronous, the program will have to wait for a signal or check a queue to see if a request has completed and retrieve a response from data repositories where the API stores its output.

A response 110 is a collection of output data and necessary information for a client to understand an API's outcome. In practice, it may include information such as data format. In 204, the program retrieves only the output data portion of each response.

Then in 205, the program 102 calls the other program 103. The two series of input and output data are provided to the program 103 in two separate calls. In another embodiment, a call for an input data series does not have to wait until all requests to an API complete; upon acquiring a series, the program 102 can pass it immediately to the program 103 so that the overall run time is minimized.

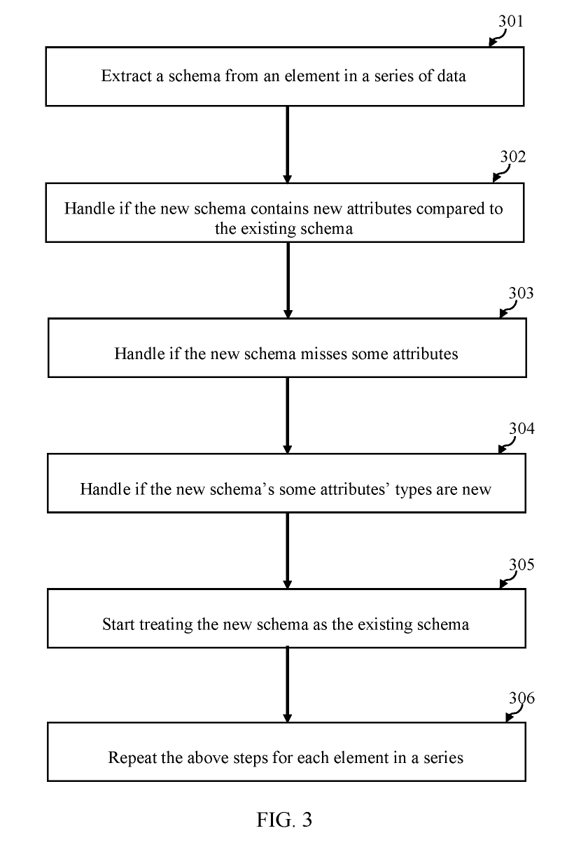

FIG. 3 shows how the program 103 generates a schema for a series of data in a certain embodiment. A schema is a document describing names, types and auxiliary information of attributes in data using consistent notations. An example of auxiliary information is whether an attribute is required in input data. An attribute is an item in data whose value is a scalar (text, number, binary or null; not list, note, object nor document). For instance, in a JSON-formatted data, an attribute is a key-value pair whose value is a scalar. A type set of an attribute is a list defining possible types of the value of an attribute.

In 301, the program generates a schema for a data element in a series. The program uses the JSON schema, XSD and YAML schema to extract and express a schema of JSON-, XML- and YAML-formatted data.

The program iteratively loops through each element in the series to create a single schema for the series. In an iteration, if new and current schemata have conflicts, the program resolves in such a way that the final schema encompasses all elements in the series. In other words, if the final schema is asked to validate elements in the series, the schema has to return true for its validation results for all elements.

In 302, the program handles one case of conflicts. If a new schema has an attribute that does not appear in the current schema the program has created so far, the resulting schema contains the attribute but marks it as not required.

In 303, the program handles another case of conflicts. If a new schema does not have an attribute that the current schema has, the resulting schema marks the missing attribute not required if the attribute is not already marked as optional.

In 304, if new and current schemata both contain an attribute with a common name but the type of the attribute is different, the resulting schema includes the type in the new schema in the attribute's type set.

In 305, after handling these conflicts, the program sets the resulting schema as the current schema. Then in 306, it repeats the steps to get the final schema for a series of data.

What is claimed is:

1. A method for generating schemata of input and output data of an API comprising:
Acquiring appropriate input data from the API's providers;
Receiving output data from the API after providing the input data to it;
Deriving schemata of the input and output data.
The method of claim 1 wherein the input or output data is JSON-, YAML- or XML-formatted.
The method of claim 1 wherein the schemata are JSON schema, YAML schema and XSD for JSON, YAML and XML values respectively.
The method of claim 1 wherein only two schemata are created for an API (one for input data and the other for output data) which handles input and output data with optional attributes by including all attributes that appeared at least once across all requests or responses and not making an attribute required if the attribute is missing in a request or response.
The method of claim 1 wherein an attribute's type set includes all types of the attribute in a series of input or output data.
